(19) United States
(12) Patent Application Publication
(10) Pub. No.: US 2015/0298764 A1
(43) Pub. Date: Oct. 22, 2015

(54) Vehicle with a driving device thats engages when the operator sits

(71) Applicant: Kent EDLUND, Kramfors (SE)

(72) Inventor: Kent Edlund, Kramfors (SE)

(73) Assignee: Kent Edlund, Kramfors (SE)

(21) Appl. No.: 14/646,390

(22) PCT Filed: Nov. 19, 2013
(86) PCT No.: PCT/SE2013/000178

§ 371 Date: May 21, 2015

(30) Foreign Application Priority Data
Nov. 22, 2012 (SE) SE1200714-2

(51) Int. Cl. B62M 6/45; B62K 5/007; B62K 15/00; B60K 28/04; B62J 1/28; B62M 6/75; B62K 5/08

(52) U.S. Cl. CPC B62M 6/45; B62M 6/75; B62K 5/007; B62K 5/08; B60K 28/04; B62J 1/28; B62K 15/006

(57) ABSTRACT

The present invention relates to a vehicle (1) intended for use in the transportation of at least one person, comprised of at least one frame (2), at least one steering device (3), at least one seating device (25), at least one driving device (4) and at least one control device (5) for engagement and disengagement of the driving force of the vehicle. A unique feature of the present invention is that the control device (5) for the engagement and disengagement of the driving device (4) consists of the vehicle's seating device (25) and that the driving device (4) is engaged when the person sits on the seating device (25) and is disengaged when the person stands up from the seating device (25).

### FIELD OF THE INVENTION

The present invention concerns a vehicle in accordance with the claims.

### BACKGROUND OF THE INVENTION

With an increasing proportion of elderly in the general population, it has become increasingly important to provide a variety of vehicles with which the elderly in a gentle way may move about. Even other people with reduced mobility due to disease and disorders sometimes need vehicles to move both short and long distances. However, it is considered by most experts that at least some movement and/or exercise is usually health for most individuals. Currently, a significant problem exists because vehicles or other mobility aids do not exist that can combine different types of propulsion where either a person's own muscle power, motor power or any combination of these are found in one and the same vehicle. It is very inconvenient and even space-consuming to have to have several different types of vehicles to get around.

Today, for example, mobility aids (devices) of the walker (rollator) type and similar are utilized as aids during movement. Known types of walkers are only designed as support aids for the user and can not be used for faster movement (transport). Thus, known walkers do not include a drive (motor) unit which may be used to propel the vehicle.

Mobility aids with which a relatively rapider movement may take place are already known. For example, there are different types of kick scooters with which the user may kick their way forward. Known kick scooters preferably do not include a drive unit. Furthermore, known kick scooters do not allow the user to sit down and rest on the mobility aid.

One problem with existing designs is that they are mainly intended to be used as one type of vehicle, unlike the present design which combines several different types of features such as a kick scooter and a motorized vehicle.

A further problem with existing designs of mobility aids is that they usually are complicated and expensive to manufacture. There is thus a need for a design which may be manufactured in a more cost effective manner.

### PRIOR ART

U.S. Pat. No. 408,718 describes a variation of a three-wheeled collapsible vehicle. The design includes a drive unit which propels the vehicle's front wheels. The design differs from the present invention. The design does not for example include a seat in accordance with the present invention which affects the drive (propulsion) of the vehicle.

Even U.S. Pat. No. 6,478,104 describes a variant of a three-wheeled collapsible vehicle. The design includes a drive unit which propels the vehicle's front wheels. The design differs from the present invention to a significant degree. For example the vehicle does not include a seat in accordance with the present invention which affects the drive (propulsion) of the vehicle.

U.S. Pat. No. 6,378,642 describes a variant of a three-wheeled vehicle. The vehicle is powered by a drive unit which propels the vehicle's front wheels. The design differs from the present invention to a significant degree. For example the design according to its description includes a hub motor and not a motor which engages the wheel's rolling surface. The design according to its description is therefore significantly different from the design according to the present patent application.

U.S. Pat. No. 4,579,188 describes a variant of a tricycle driven by a drive unit which propels the bicycle's front wheel. Driving power is provided via friction driving. The design, however, differs to a significant extent from the design according to the present patent application because it does not include a seat which operates the drive unit's engagement with the front wheel.

### PURPOSE OF THE INVENTION

The main purpose of the present invention is to create a substantially improved mobility aid for moving at least one person. Another purpose of the present invention is to provide a mobility aid with which the user may move himself in at least one first manner and in at least one second manner. A further purpose of the present invention is that it may be used as a kick scooter. A yet further purpose of the present invention is to create a vehicle that may be used as a walker (rollator). A still further purpose of the present invention is to create a vehicle that may be used by a person in a sitting position.

### BRIEF DESCRIPTION OF THE DRAWINGS

In the following detailed description of the present invention, reference and references to the following figures will occur. These figures are briefly described in the following figure list.

FIG. 1 shows schematically a first embodiment of the present invention viewed in perspective obliquely from above.

FIG. 2 shows schematically the first embodiment viewed from above.

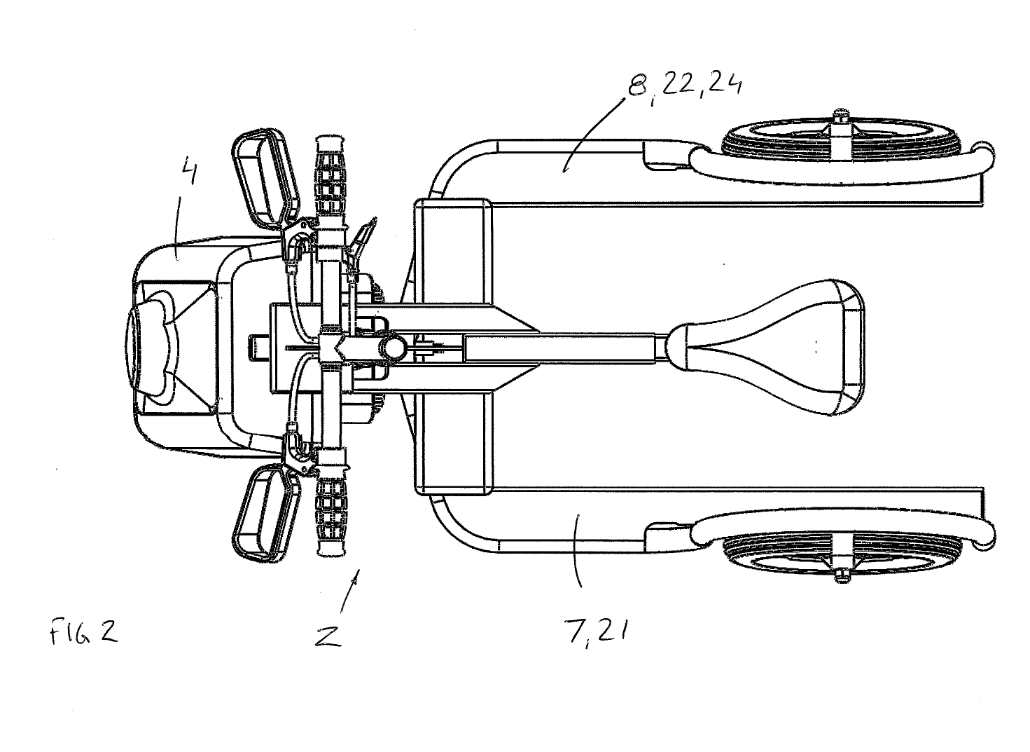

FIG. 3 shows schematically the first embodiment viewed from the side.

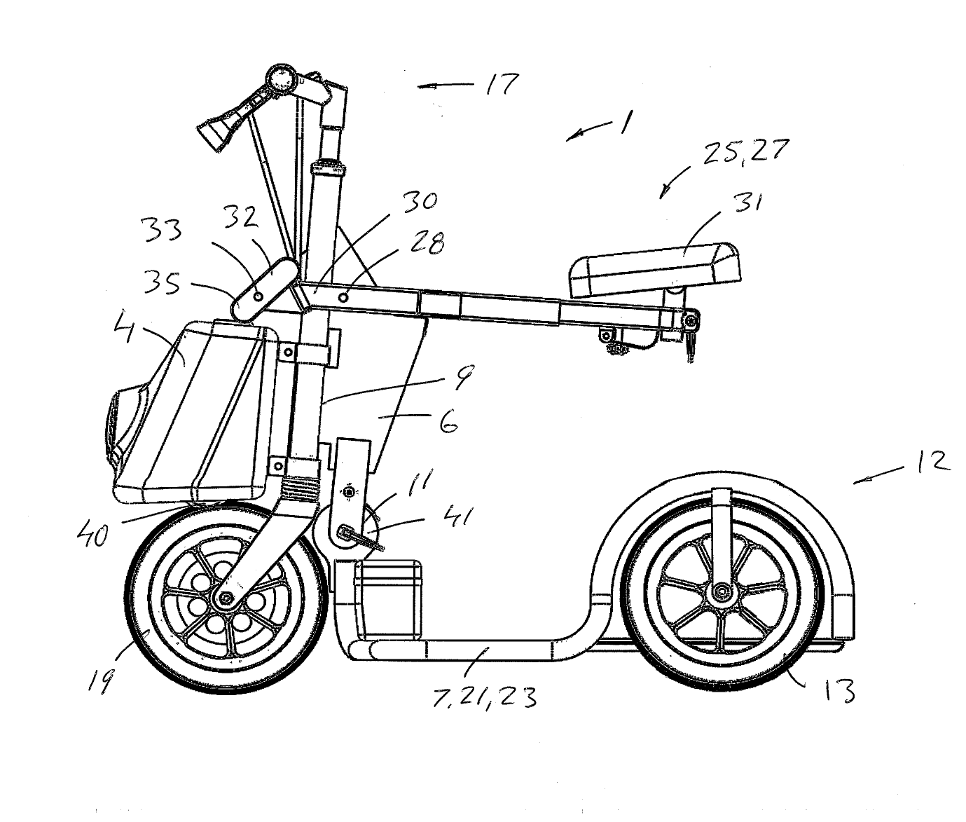

FIG. 4 shows schematically the first embodiment viewed from the front side.

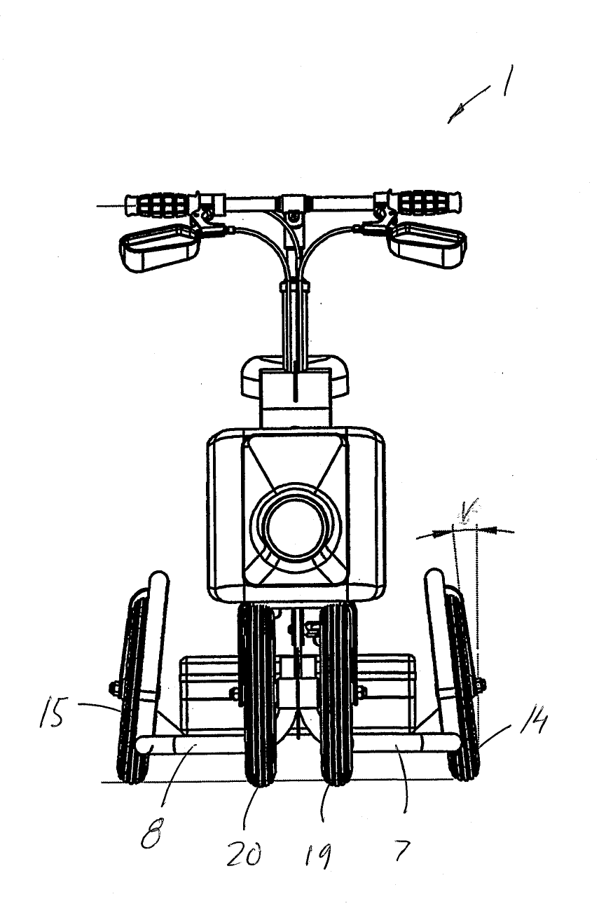

FIG. 5 shows schematically the first embodiment viewed from the rear side.

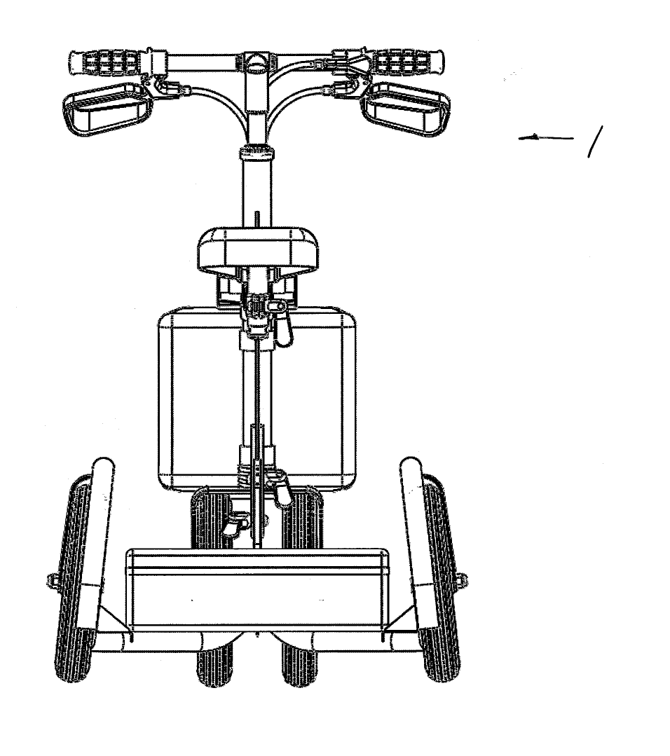

FIG. 6 shows a more detailed view of the vehicle from the side.

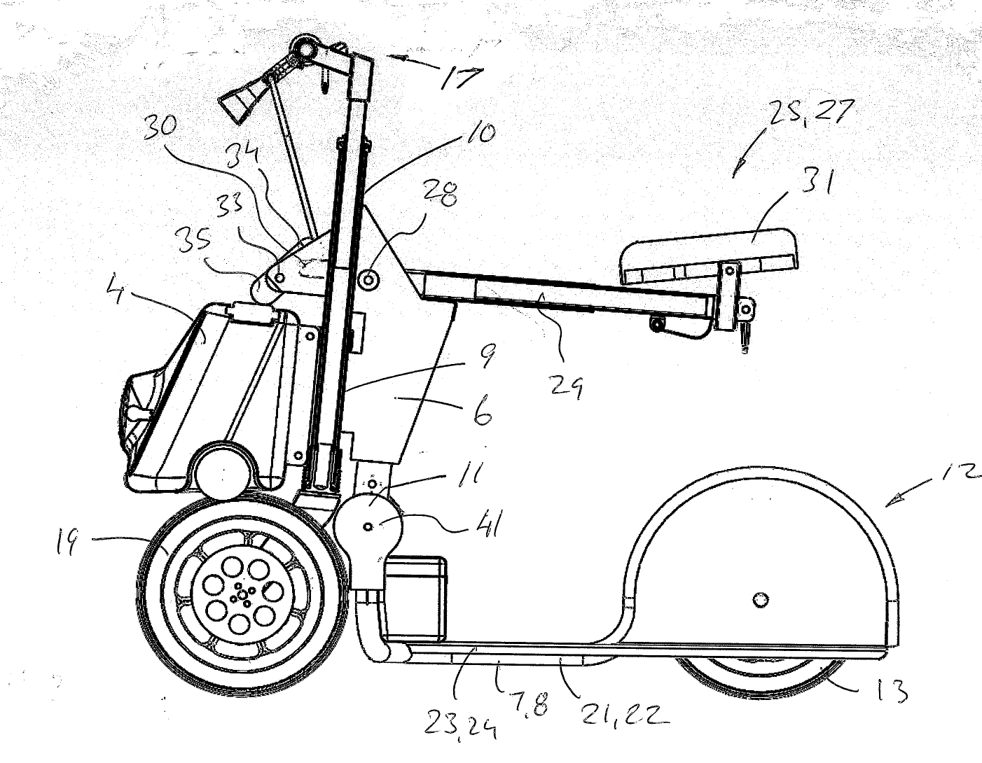

### DETAILED DESCRIPTION OF THE INVENTION

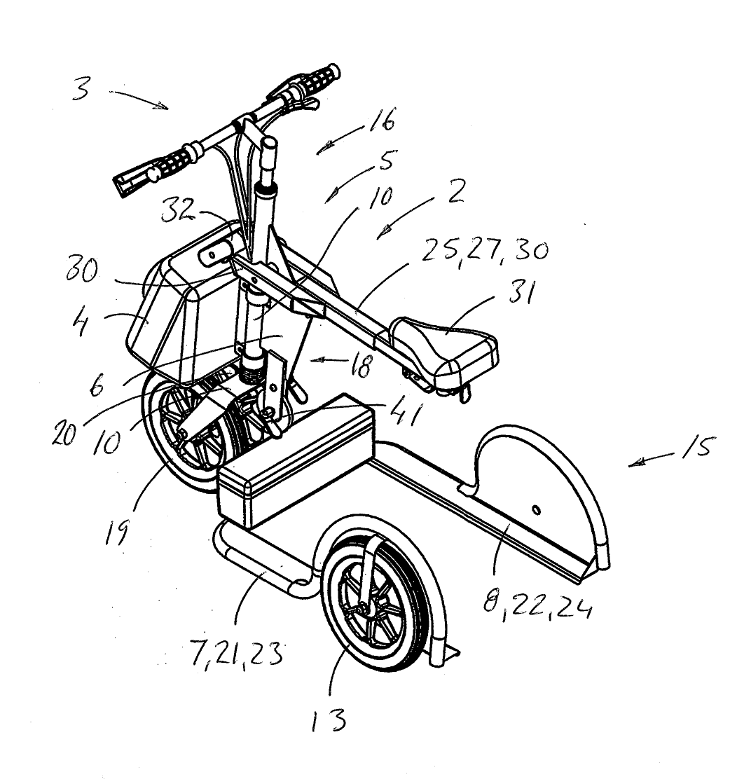

Referring to FIG. 1, a vehicle 1 in accordance with the present application is shown. The vehicle 1 is comprised of at least one frame 2, at least one steering device 3, and at least one driving device 4, and at least one control device 5 for the driving device 4.

The frame's 2 design may vary within the scope of the present application. In the exemplifying embodiment, however, the frame is comprised of at least one first frame section 6, at least one second frame section 7 and at least one third frame section 8. The first frame section 6 includes at least one connecting part 9 to at least one front fork 10 included in the steering device 3. The first frame section 6 further includes at least one second connecting part 11 to which the second frame 7 and the third frame are connected. Preferably the second frame part 7 and the third frame 8 are pivotally connected to connecting part 11 in the first frame section 6.

To the second frame section's 7 free end 12 or in the vicinity of the free end, at least one first wheel 13 is connected. To the third frame section's 8 free end 14 or in the vicinity of the free end, at least one second wheel 15 is connected. The size of the wheels may vary within the scope of the present invention. The connection of the first wheel 13 and second wheel 15 to the second frame section 7 and the third frame section 8 is accomplished with previously known techniques and this is why this technique is not describe in more detail in this patent application.

The present vehicle includes at least one steering device 3. In the exemplifying embodiment, the steering device 3 consists of at least one front fork 10 pivotally arranged (connected) to the frame's first section via at least one bearing (not shown in figures). The bearing may consist of at least one bearing such as at least one headset or similar. At least one steering control 17 is connected to the front fork's 10 upper end 16. In the exemplifying embodiment, the steering control 17 consists of the at least one bar (steering bar) 17 or the like. In the front fork's 10 second end 18, at least one front wheel 19 is connected. In the embodiment exemplifying in the figures, at least one first front wheel 19 and at least one second front wheel 20 are pivotally connected to the front fork. The design of the front fork 10 may vary greatly within the scope of the present application.

The design includes at least one first support device 21 and at least one second support device 22 on which the user may stand on during movement. In the exemplifying embodiment, the first support device 21 consists of a first footrest 23 which is placed on the top side (during normal use) of the second frame section 7. In the exemplifying embodiment, the second support device 22 consists of a second footrest 24 which is placed on the top side of the third frame section 8. The first footrest 23 may stretch along all or part of the second frame section's 7 length. The second footrest 24 may stretch along all or part of the third frame section's 8 length.

The vehicle's driving device 4 is comprised of at least one drive motor which propels (powers) at least one of the vehicle's wheels. Preferably, the drive motor propels at least one of the vehicle's front wheels. In the exemplifying embodiment, the drive motor propels the first front wheel and the second front wheel. The driving force on the front wheel is accomplished via at least one driving wheel 40 which during driving bears down against the first wheel and the second wheel. The transfer of torque from the driving wheel is accomplished via friction driving by contact with the wheels' surface tracks. The driving wheel is preferably pressed down against the first wheel and the second wheel. The driving wheel may also be partially pressed down between the first wheel and the second wheel.

The drive motor in the exemplifying embodiment consists of at least one electric motor which directly or via at least one gear propels (drives) at least one driving wheel. The electric motor is driven by electrical power from at least one accumulator. The accumulator's placement may vary.

A unique feature of the present invention is that the vehicle includes a seating device 25 which embodies an activating mechanism 26 for engagement and disengagement of propulsion of at least one of the vehicle's front wheels. The seating device 25 includes at least one arm 27 which is pivotally arranged around at least one bearing (axis of rotation) 28 in the frame. The bearing divides the arm 27 into one first arm part 29 and one second arm part 30. At least one seat 31 is connected to the first arm part. The position of the seat 31 affects the driving wheel's position relative to the vehicle's front wheel.

During a downward rotation of the seating device's 25 first arm part 29 with the included seat 31 in a downward direction, the second arm part 30 affects at least one control member 32 to bring the driving wheel towards the direction of the front wheel to the point where the driving wheel is in contact (engaged) with the front wheels. The control member 32 is pivotally arranged around a rotational axle 33. Upon rotation of the seating device's 25 first arm part 29 with the included seat 31 in the other direction, the driving wheel (for example, by spring back) is moved in the direction from the front wheel whereby contact with and propulsion of the front wheel stops. The movement of the driving wheel downward toward the front wheel (the front wheels) is accomplished by the second arm part affecting the control member's one portion 34 in the upward direction wherein rotation of the control member 32 occurs around the rotational axle 33 causing the control member's second portion 35 to press against the driving wheel's top side or similar and thereby affect the driving wheel to be moved down against the front wheel or front wheels.

In the exemplifying embodiment, control of vehicle's speed is accomplished via at least one throttle 36 of a previously known type. Furthermore, the bar is provided with at least one first handle 37 and at least one second handle 38.

The design further includes at least one brake function. The brake function consists of previously known techniques and this is why it is not described in more detail in this patent application. The braking function is preferably operated via at least one handle 39 or the like.

In the exemplifying embodiment, the vehicle includes at least one articulated joint (hinge) 41, or other feature (design) which allows the vehicle to be collapsible, with which the vehicle's second and third frame section may be folded together with the first frame section. The joint may include a quick-lock (coupler) or the like.

In the exemplifying embodiment, the wheels are inwardly inclined according to the angle V. The design has the technical effect of the vehicle becoming more stable than with a straight angle. The angle V is preferably in the range of 4 to 10 degrees. In the preferred embodiment, the angle V is in the range of 5 to 7 degrees and is preferably 6 degrees. In alternative embodiments, the wheel may be straight or essentially straight or of another for the purpose suitable angle.

In the detailed description of the present invention, design details may have been omitted which are apparent to skilled persons in the field of the present device. Such obvious design details are included to the extent necessary so that the proper and full performance of the present invention is achieved.

Even if certain preferred embodiments have been described in detail, variants and modifications of the method and device may become apparent for specialists in the field of the invention. All such modifications and variants are regarded as falling within the scope of the following claims.

1. A vehicle intended for use in the transportation of at least one person, comprised of at least one frame (2), at least one steering device (3), at least one seating device (25), at least one driving device (4) and at least one control device (5) for engagement and disengament of the driving force of the vehicle wherein the control device (5) for the engagement and disengagement of the driving device (4) consists of the vehicle's seating device (25) and that the driving device (4) is engaged when the person sits on the seating device (25) and is disengaged when the person stands up from the seating device (25).

2. A vehicle according to claim 1 wherein the seating device (25) includes at least one arm (28) that is pivotally arranged to the frame (2) via at least one bearing, said bearing dividing the arm into a first part (29) to which at least one seat (31) is connected and at least one second arm part (30) which, via at least one control member (32) affects the driving wheel's (40) position relative to the vehicle's front wheel.

3. A vehicle according to claim 2 wherein the transfer of torque from the driving wheel (40) to the front wheel (19), or the front wheel's (19, 20) is accomplished by friction driving.

4. A vehicle according to claim 3 wherein the vehicle includes at least one first front wheel (19) and at least one second front wheel (20).

5. A vehicle according to claim 4 wherein the driving wheel (40) during operation is engaged between the first front wheel (19) and the second front wheel (20).

6. A vehicle according to claim 5 wherein the wheels are angled according to angle V within the interval of 5 to 7 degrees.

7. A vehicle according to claim 1 wherein the vehicle may be used as a kick scooter, walker, rollator and also a driven vehicle.

8. A vehicle according to claim 1 wherein the vehicle includes at least one articulated joint (41), or other design which make the vehicle collapsible, with which the vehicle's second and third frame sections may be folded together with the first frame section.
